(19) United States
(12) Patent Application Publication
(10) Pub. No.: US 2023/0039118 A1
(43) Pub. Date: Feb. 9, 2023

(54) FALL ARREST INDICATOR

(71) Applicant: Beacon Group International Products Ltd., Hereford (GB)

(72) Inventor: Michael CHING, Stade (CH)

(21) Appl. No.: 17/759,340

(22) PCT Filed: Jan. 25, 2021
(86) PCT No.: PCT/GB2021/050168

§ 371 Date: Jul. 22, 2022

(30) Foreign Application Priority Data
Jan. 24, 2020 (GB) 2001028.6

(51) Int. Cl. A62B 35/00

(52) U.S. Cl. CPC A62B 35/0037; A62B 35/0012

(57) ABSTRACT

A fall arrest indicator is disclosed for indicating whether a fall arrest event has occurred, the fall arrest indicator includes an actuator, the actuator being reconfigurable between a first configuration and a second configuration; an electronic alarm circuit comprising an alarm for indicating a fall arrest event; and, activating means, wherein the activating means is arranged to reconfigure the alarm circuit between an inactive state in which the alarm is inactive and an operative state in which the alarm is activated, in dependence of a reconfiguration of the actuator between the first and second configurations.

### CROSS-REFERENCE TO RELATED APPLICATIONS

The present application is the national stage application pursuant to 35 U.S.C. § 371 of International Patent Application No. PCT/GB2021/050168, filed Jan. 25, 2021, which claims priority from United Kingdom Patent Application No. 2001028.6, filed Jan. 24, 2020, which applications are incorporated herein by reference in their entireties.

### BACKGROUND

The present invention relates to a fall arrest indicator for indicating whether a fall arrest event has occurred. The present invention relates particularly, but not exclusively, to a fall arrest indicator for indicating whether a safety harness worn by a user has been subject to a fall arrest event.

### INTRODUCTION

When working at height, it is critical that the safety systems and personal protection equipment (PPE) utilised by a worker are in good working condition and properly maintained such that if a fall does occur, the equipment will function correctly and prevent any injury or loss of life. There are various standards and guidelines which detail the minimum safety requirements of different forms of personal protection equipment. One such requirement relates to harnesses which are worn by users and which serve as an anchor point to a tether or similar for arresting a fall of a wearer during a fall event. Once a harness has been subject to the forces associated with a fall event, the harness must be replaced. In order to meet this requirement, it is common for a harness to be inspected regularly throughout its operational life to ensure that any damage is detected early, and so that the damage can either be rectified or the harness can be removed from use.

One method of detecting when a harness has been used to arrest a fall involves the use of specific stitch patterns in the webbing that is used to form the harness. These stitch patterns are designed such that if subjected to a large force, such as the forces associated with a fall arrest, then the stitching will fray and break, creating a visible indication that a fall has occurred. By inspecting the stitch pattern for damage, a user can assess the damage suffered to the harness and ascertain whether the harness is required to be removed from active use. However, a problem with this method of detecting damage is the stitching is commonly exposed to the elements and can become damaged other than via a fall arrest, without affecting the effectiveness of the harness. If this damage is found and mistakenly identified as damage received when arresting a fall, then the harness may be taken out of service prematurely, which increases cost and is generally inconvenient for users.

A solution to this problem has been proposed which includes a more apparent indication that the harness has suffered a fall event. This solution makes use of a hidden label which is covered by a fold of fabric that is secured by stitching. The stitching is designed to break when exposed to large forces associated with arresting a fall, such that the label becomes exposed. However, the label can be easily missed, especially if the person inspecting the harness is inexperienced and unfamiliar with the equipment.

It is therefore an objective of the present invention to provide a technical solution to at least some of the above-mentioned problems.

### SUMMARY

In accordance with the present invention, as seen from a first aspect, there is provided a fall arrest indicator for indicating a fall arrest event, the fall arrest indicator comprising an actuator, the actuator being reconfigurable between a first configuration and a second configuration; an electronic alarm circuit comprising an alarm for indicating a fall arrest event; and activating means; wherein the activating means is arranged to reconfigure the alarm circuit between an inactive state in which the alarm is inactive and an operative state in which the alarm is activated, in dependence of a reconfiguration of the actuator between the first and second configurations.

In an embodiment, the activating means reconfigures the alarm circuit from the inactive state to the active state in dependence of a reconfiguration of the actuator from the first configuration to the second configuration. The first configuration may comprise a collapsed, contracted or folded configuration of the actuator and the second configuration may comprise an extended or unfolded configuration of the actuator.

In an embodiment, the fall arrest indicator comprises a casing which is secured to a first end portion of the actuator. The electronic circuit is preferably disposed within the casing.

In an embodiment, the electronic circuit comprises a switch, and reconfiguration of the actuator between the first and second configurations causes the switch to reconfigure between an open circuit state and a closed circuit state.

In an embodiment, the activating means comprises an attachment member, preferably an inelastic member, which is secured at a first end thereof to an electrically insulating medium disposed between electrical contacts of the switch and at a second end thereof to the actuator.

In an embodiment, the electronic circuit is arranged in fixed relation relative to a first end portion of the actuator and the attachment member is secured at the second end thereof to a second end portion of the actuator.

In an alternative embodiment, the activating means comprises a controller for controlling operation of the alarm. The activating means preferably further comprises a tag and a sensor or reader for interrogating the tag.

In an embodiment, the sensor or reader is arranged to sense or interrogate respectively, the tag, as the actuator reconfigures between the first and second configuration, and output a signal to the controller.

In an embodiment, the actuator is arranged in the first configuration toward a first end of the casing and the sensor or reader is disposed at a second end of the casing, and the tag is disposed upon the actuator.

In an embodiment, the actuator comprises a strap or webbing, and the first configuration comprises a folded configuration of the webbing and the second configuration comprises an unfolded configuration of the webbing.

In accordance with a second aspect of the present invention, there is provided a harness comprising a fall arrest indicator according to the first aspect.

These and other objects, features, and advantages of the present invention will become readily apparent upon a review of the following detailed description of the invention, in view of the drawings and appended claims.

### BRIEF DESCRIPTION OF THE DRAWINGS

Embodiments of the present invention will now be described by way of example only and with reference to the accompanying drawings in which:

FIG. 1 is a schematic illustration of a fall arrest indicator according to an embodiment of the present invention;

FIG. 2 is a schematic illustration of a cross-section through a portion of the fall arrest indicator illustrated in FIG. 1 comprising a casing;

FIG. 3 is a schematic illustration of a cross-section through a portion of a fall arrest indicator according to an alternative embodiment of the present invention; and,

FIG. 4 is a schematic illustration of a harness according to an embodiment of the present invention.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

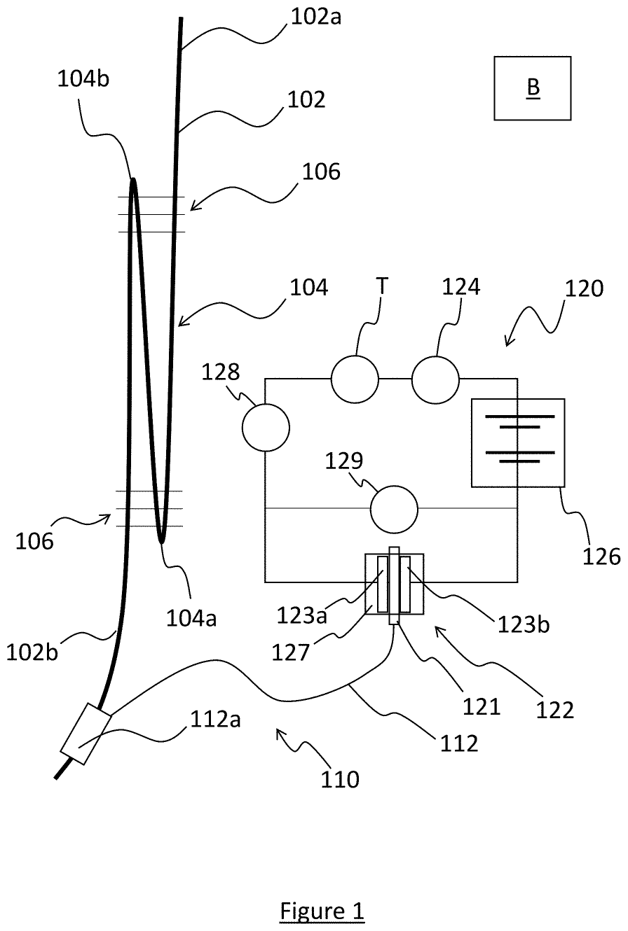

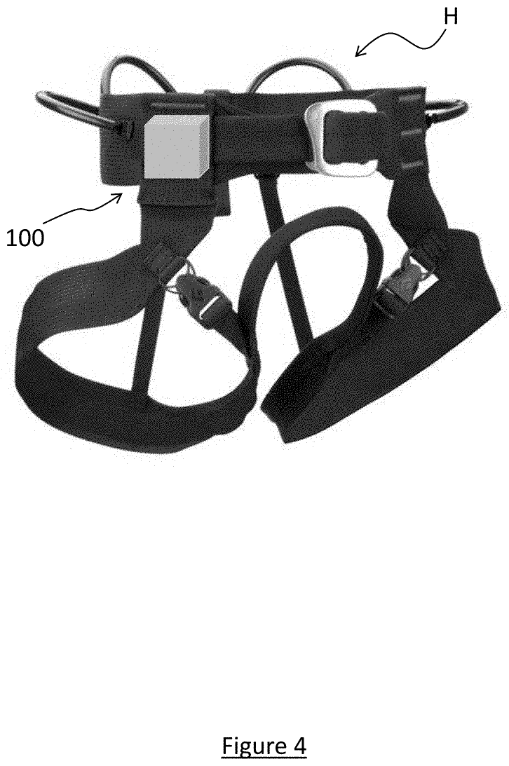

Referring to FIG. 1 of the drawings, there is illustrated a fall arrest indicator (100) according to an embodiment of the present invention, for alerting a user that a harness (H—see FIG. 4 of the drawings) or other safety mechanism, such as a lanyard, has sustained damage as a result of a fall event. The indicator (100) generally comprises an alarm circuit (120) for alerting a user that a fall event has occurred, an actuator (102) which may be integrally formed on or with a safety harness (H) or lanyard (not shown) for example, and activating means (110) for activating the alarm circuit (120).

In an embodiment, the actuator (102) comprises an integral portion of a safety harness (H) (see FIG. 4) or lanyard and may comprise a length of webbing. However, in an alternative embodiment, the actuator may comprise a resiliently deformable member or assembly, such as a folded section of plastics or metal. Importantly, the actuator is arranged to reconfigure between a shortened length and an extended length and while the following description references the use of a length of webbing as the actuator, the skilled reader will recognise that alternative forms of actuator may be used. When forming part of a harness (H), the length of webbing is located on a region of the safety harness (H) which will be subject to the forces associated with a fall arrest. The length of webbing (102) is generally comprised of a fabric material, such as a generally woven nylon material, which is of a significant strength to arrest a fall of a user.

The length of webbing (102) comprises a first and second end portion (102a, 102b) and a contracted or folded region (104) disposed between the first and second end portions (102a, 102b). The folded region (104) comprises an S-shape and thus comprises a first fold and a second fold (104a, 104b) which is opposed to the first fold, such that the folded portions of the webbing overlap each other. The webbing (102) forming the first and second fold is secured in the folded configuration via a frangible stitching (106) or stitch pattern which is designed to break under a large amount of force, such as that associated with a fall event. The stitching (106) is disposed principally proximate the first and second fold (104a, 104b) of the folded region (104), such that the stitches will be subject to the greatest amount of force during a fall event. Once the stitching (106) is broken, the folded region (104) becomes unfolded and can extend to the full length of the webbing (102).

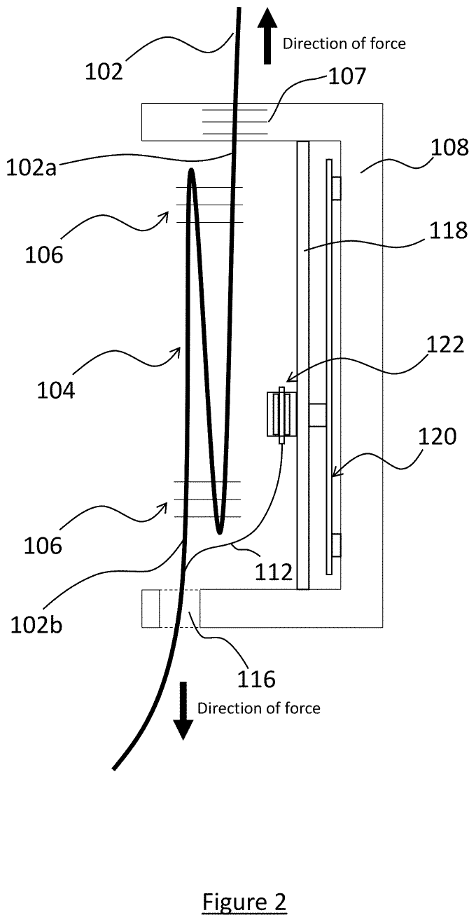

Referring to FIG. 2 of the drawings, the fall arrest indicator (100) additionally comprises a protective casing (108—not shown in FIG. 1) which protects the alarm circuitry (120) from damage during use. The casing (108) is arranged to shroud the folded region (104) and is fixedly attached at a first end thereof to the webbing (102) via stitching (107) at a position between the first end portion (102a) of the webbing (102) and the folded region (104). A portion of the webbing (102) disposed at the second end portion (102b) is arranged to pass out through an aperture (116) formed within the casing (108). In this respect, the second end portion (102b) of the webbing is arranged to pass freely through the aperture (116).

The electronic circuit (120) is affixed to the casing (108), typically along an interior side thereof, and protected by a removable covering (not shown) to prevent damage. Referring again to FIG. 1 of the drawings, the alarm circuit (120) comprises a switch (122) which is arranged to allow selective operation of the alarm circuit (120), a power source (126) electronically coupled to the switch (122) for powering the alarm circuit (120), and an alarm (124) electronically coupled to the switch (122) and the power source (126), such that completion of the alarm circuit (120) via operation of the switch (122) causes the alarm (124) to be activated. The alarm (124) is preferably an acoustic alarm which emits a loud sound when the alarm circuit (120) is completed. Alternatively, the alarm (124) may comprise a visual indicator such as an LED array which emits a light when the alarm circuit (120) is completed. Alternatively, the alarm (124) comprises a combination of visual and acoustic indicators.

The power source (126) may comprise a battery arrangement, which is housed within the casing (108). In this respect, the casing may comprise a cover (118) which can be detachably secured to the casing to allow access to a battery compartment (not shown) to permit a replacement of batteries. Alternatively, the power source (126) comprises a fixed battery arrangement which is electronically coupled to a re-charging means, such as a solar cell or mains supply, via an electronic port (not shown) disposed on the casing.

In an embodiment, as illustrated in FIGS. 1 and 2 of the drawings the switch (122) comprises two electrically conductive switch contacts (123a, 123b) arranged in a “normally closed” switch arrangement. However, the contacts (123a, 123b) are held separated by a selectively removable electrically insulating medium (121), such that while the medium (121) is between the two contacts (123a, 123b), the alarm circuit (120) is ‘open’ and no flow of electricity is permitted, thereby preventing activation of the alarm (124). Once the medium (121) is removed, the switch contacts (123a, 123b) are biased to contact one another, thereby completing the alarm circuit (120) and activating the alarm (124) to alert the user. The “held open” configuration of the “normally closed” switch (122) ensures that there is no power drain until the alarm (124) is activated, thereby reducing the requirement to replace or recharge the power source (126) until the alarm (124) is activated. This has the additional benefit of removing the requirement to check the power source (126) is functional, thus reducing the maintenance requirements.

In an embodiment, the switch (122) is surrounded by a binding (127) which applies a constant pressure to the switch contacts (123a, 123b) to urge the switch contacts (123a, 123b) together. This ensures that the insulating medium (121) is not removed accidentally, and it additionally ensures that the switch (122) will immediately close once the insulating medium (121) is removed.

In this embodiment, the activating means (110) for activating the alarm (124) comprises an attachment member (112) which is secured at a first end thereof to the insulating medium (121). The attachment member (112) may comprise a tether, such as piece of rope, cabling or wire or other inelastic material. A second end of the attachment member (112) is fixedly secured to the webbing at a position between the second end portion (102b) and the folded region (104), via a clamp (112a), stitching or a glue, for example. In this respect, the skilled reader will recognise that owing to the coupling of the electronic circuit (120) to the first end portion (102a) of the webbing (102) via the casing (108), and the coupling of the attachment member (112) to the second end portion (102b) of the webbing (104), then in the event of a fall event occurring which causes the folded region (104) to unfold, the separation of the second end of the attachment member (112) from the electronic circuit (120) will increase. Consequently, the physical coupling of the attachment member (112) to the insulating medium (121) causes the insulating medium (121) to become pulled out from between the switch contacts (123a, 123b) thereby enabling the switch contacts (123a, 123b) to form an electrical contact and complete the alarm circuit (120) to activate the alarm (124).

In an embodiment, the fall arrest indicator (100) further comprises a transceiver (T) for communicating with a remote base station (B). It is envisaged that the indicator (100) will comprise a pre-configured identity so that the base station (B) can identify the specific indicator (and thus user) from a plurality of indicators. The transceiver (T) is disposed within the alarm circuit (120) and is arranged to communicate with the base station (B) via radio frequency (RF) communication, such as within the 433 MHz frequency band, and with a power of approximately 22 dB. When a fall event occurs and the switch contacts (123a, 123b) close, the transceiver (T) is arranged to transmit a distress signal, which includes the indicator identity and location, to the base station (B). Upon receipt of the distress signal, the base station (B) is arranged to propagate the distress signal such as via a short message service (SMS) signal over the global systems for mobile communication (GSM) network, and/or via email for example to a dedicated IP address. In an embodiment, the distress signal may further include details relating to local temperature and user movement, obtained via respective sensors (not shown). In this respect, when the indicator (100) is being used in a location where there is no mobile communication network, a distress signal can still be communicated to the relevant responders.

When the transceiver (T) is activated, it remains active and is arranged to transmit the distress signal periodically, such as every 5 seconds. Once the distress signal has been received, the base station (B) is arranged to acknowledge receipt and send a confirmation signal to the transceiver (T). This confirmation may be communicated to the user of the indicator (100) via an LED (128) disposed on the indicator (100), for example.

In an embodiment, the indicator further comprises a test button (129) for testing the communication link between the transceiver (T) and the base station (B). The test button (129) is arranged to close a circuit path bypassing the switch (122). When the button (129) is pressed, the transceiver (T) transmits a test signal to the base station (B) and the circuit (120) remains active for a limited time, namely a reception window, such as 5 seconds, for receipt of a handshake signal from the base station (B). The test signal may include details relating to the power level of the battery (126) so a record can be maintained remotely at the base station (B). Moreover, the battery level may also be indicated to the operator an LED display sequence, such as a steady illumination of the LED (128) for 3 seconds.

Upon receipt of the handshake signal, the LED is arranged to output a visual display sequence, such switch on and off or blink 5 times, to confirm the with the user that a communication link has been established between the indicator (100) and the base station (B). If the handshake signal is not received within the reception window, then the circuit (120) is deactivated. In this case, the test button (129) will need to be pressed again to establish a connection with the base station (B).

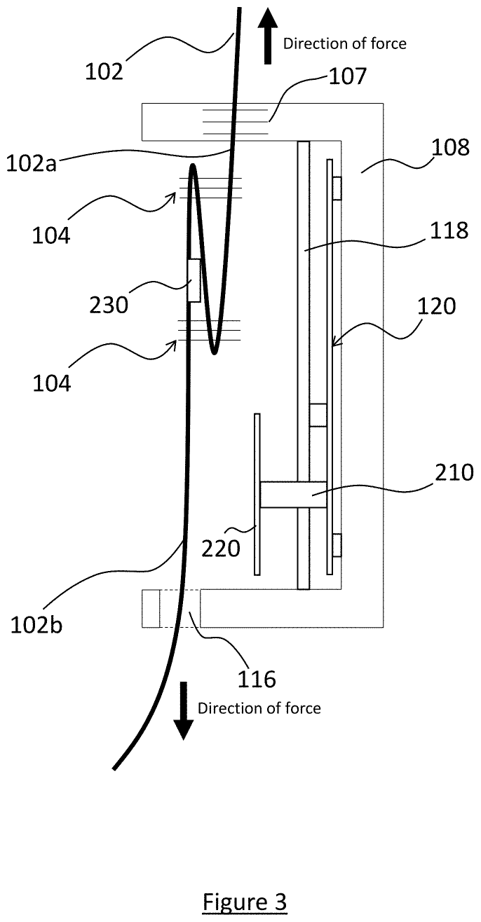

Referring to FIG. 3 of the drawings there is illustrated a fall arrest indicator (100) according to a further embodiment of the present invention. The features of this further embodiment comprise features which are common to the features of the embodiment described above, and these have been referenced with the same reference numerals. However, in this further embodiment, the activating means (110) comprises a controller (210) for selectively controlling operation of the alarm (124). A reader (220) is arranged to sense or otherwise interrogate a tag (230), such as a magnetic tag or RFID tag, respectively, and output a signal to the controller (210).

In the embodiment illustrated in FIG. 3 of the drawings, the tag (230) is incorporated within the folded region (104) of the webbing (102) and preferably disposed toward the second end portion (102b) of the webbing (102). The folded region (104) is held within the casing (108) toward a first end thereof. The sensor or reader (220) is disposed toward a second end of the casing (108), proximate the aperture (116). In this respect, in the event of a fall occurring which causes the frangible stitches (106) to break, the folded region (104) will unfold and the webbing (102) will pass out through the casing (108) via the aperture (116), owing to the secure coupling of the casing (108) at a first end thereof to the webbing (102). The tag (230) will thus pass adjacent the sensor/reader (220) during the movement of the webbing (102) and become sensed/interrogated by the sensor/reader (220). The sensor/reader (220) is subsequently arranged to output a signal to a controller (210) to cause the alarm (124) to generate the acoustic and/or visual indication of a fall arrest.

In view of the above, it is evident that the fall arrest indicator of both described embodiments is arranged to provide a clear indication that a fall event has occurred in relation to a harness or lanyard or similar, to which the fall arrest indicator is incorporated. Select embodiments of the invention only have been described and illustrated, and it will be readily apparent that other embodiments, modifications, additions and omissions are possible within the scope of the invention.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A fall arrest indicator for indicating a fall arrest event, the fall arrest indicator comprising:
an actuator which is reconfigurable between a first configuration and a second configuration;
an electronic alarm circuit comprising an alarm for indicating a fall arrest event; and
activating means;
wherein the activating means is arranged to reconfigure the alarm circuit between an inactive state in which the alarm is inactive and an operative state in which the alarm is activated, in dependence of a reconfiguration of the actuator between the first and second configurations.

2. The fall arrest indicator according to claim 1, wherein the activating means reconfigures the alarm circuit from the inactive state to the active state in dependence of a reconfiguration of the actuator from the first configuration to the second configuration.

3. The fall arrest indicator according to claim 1, wherein the first configuration comprises a contracted or folded configuration of the actuator and the second configuration comprises an extended or unfolded configuration of the length of webbing.

4. The fall arrest indicator according to claim 1, further comprising a casing which is secured to a first end portion of the webbing.

5. The fall arrest indicator according to claim 4, wherein the electronic circuit is disposed within the casing.

6. The fall arrest indicator according to claim 1, wherein the electronic circuit comprises a switch, and reconfiguration of the actuator between the first and second configurations causes the switch to reconfigure between an open circuit state and a closed circuit state.

7. The fall arrest indicator according to claim 6, wherein the activating means comprises an attachment member which is secured at a first end thereof to an electrically insulating medium disposed between electrical contacts of the switch and at a second end thereof to the actuator.

8. The fall arrest indicator according to claim 7, wherein the electronic circuit is arranged in fixed relation relative to a first end portion of the length of webbing and the attachment member is secured at the second end thereof to a second end portion of the actuator.

9. The fall arrest indicator according to claim 7, wherein the attachment member comprises a substantially inelastic tether.

10. The fall arrest indicator according to claim 1, wherein the activating means comprises a controller for controlling operation of the alarm.

11. The fall arrest indicator according to claim 10, wherein the activating means further comprises a tag and a sensor or reader for interrogating the tag.

12. The fall arrest indicator according to claim 11, wherein the sensor or reader is arranged to sense or interrogate respectively, the tag, as the actuator reconfigures between the first and second configuration, and output a signal to the controller.

13. The fall arrest indicator according to claim 11, wherein the electronic circuit is disposed within the casing, and wherein the actuator is arranged in the first configuration toward a first end of the casing and the sensor or reader is disposed at a second end of the casing.

14. The fall arrest indicator according to claim 13, wherein the tag is disposed upon the length of webbing.

15. The fall arrest indicator according to claim 1, wherein the actuator comprises a strap or webbing.

16. The fall arrest indicator according to claim 15, wherein the first configuration comprises a folded configuration of the webbing and the second configuration comprises an unfolded configuration of the webbing.

17. The fall arrest indicator according to claim 1, further comprising a transceiver for communicating with a remote base station.

18. The fall arrest indicator according to claim 17, wherein the transceiver is arranged to communicate a distress signal to the base station when the alarm circuit is activated.

19. A harness comprising a fall arrest indicator according to claim 1.
